(19) United States
(12) Patent Application Publication
(10) Pub. No.: US 2026/0044166 A1
(43) Pub. Date: Feb. 12, 2026

(54) SEMICONDUCTOR DEVICE AND METHOD FOR CONTROLLING THE SEMICONDUCTOR DEVICE

(71) Applicant: Renesas Electronics Corporation, Tokyo (JP)

(72) Inventor: Wataru ISHIJIMA, Tokyo (JP)

(21) Appl. No.: 19/264,967

(22) Filed: Jul. 10, 2025

(30) Foreign Application Priority Data
Aug. 8, 2024 (JP) 2024-131938

(51) Int. Cl. G05F 1/565; G05F 1/63

(52) U.S. Cl. CPC G05F 1/565; G05F 1/63

(57) ABSTRACT

A semiconductor device capable of stabilizing the output voltage of a linear regulator even when there are variations in operating conditions or load conditions. The linear regulator steps down a primary power supply voltage to a secondary voltage and outputs the secondary voltage. The variable resistor is connected in series with the power supply line with respect to the output voltage of the linear regulator. The ADC detects a voltage corresponding to the output voltage of the linear regulator. The control circuit controls the resistance value of the variable resistor based on the detected output voltage.

### CROSS-REFERENCE TO RELATED APPLICATIONS

The disclosure of Japanese Patent Application No. 2024-131938 filed on Aug. 8, 2024, including the specification, drawings and abstract is incorporated herein by reference in its entirety.

### BACKGROUND

This disclosure relates to a semiconductor device and a control method for a semiconductor device, specifically to a semiconductor device with a linear regulator and a control method for such a semiconductor device.

There are disclosed techniques listed below. [Patent Document 1] Japanese Unexamined Patent Application Publication No. 2005-341018

As related technology, Patent Document 1 discloses a drive circuit for driving capacitive loads such as liquid crystal panels. Patent Document 1 discloses a drive circuit having an operational amplifier, an operation state detection circuit, and a variable resistor. The operational amplifier amplifies an input signal and outputs the amplified signal to the capacitive load. The operation state detection circuit detects the operation state of the amplification circuit with respect to the capacitive load. The variable resistor is connected to the output of the amplification circuit, and its resistance value is controlled according to the operation state detected by the operation state detection circuit.

The operation state detection circuit detects that the operation state is a driving state for charging and discharging the capacitive load when the output current of the operational amplifier is greater than a reference value. Conversely, the operation state detection circuit detects that the operation state is a steady state where the capacitive load is not being charged or discharged when the output current of the operational amplifier is less than the reference value. The resistance of the variable resistor is controlled to different values depending on whether the operation state is a driving state or a steady state. More specifically, when the operation state is a driving state, the resistance value of the variable resistor is controlled to be smaller than when the operation state is a steady state.

### SUMMARY

In semiconductor devices such as Micro Controller Units (MCUs), linear regulators such as Low Drop Out (LDO) regulators are incorporated. The linear regulators require desired phase margin characteristics. The phase margin can be improved by inserting a VCL resistor in series with the power supply line between the output of the linear regulator and the ISOVCL terminal, which is an external terminal.

However, the phase margin varies depending on the primary power supply voltage, internal capacitance, and external resistance. After the design of the semiconductor device, if the load conditions such as the primary power supply voltage, internal capacitance, and external resistance change, the phase margin may deteriorate. Therefore, it is desired that the phase margin can be ensured even if the load conditions change in the semiconductor device.

Other problems and novel features will become apparent from the description of this specification and the accompanying drawings.

According to one embodiment, a semiconductor device is provided. The semiconductor device includes a linear regulator that outputs a secondary voltage, a variable resistor connected in series with the output voltage of the linear regulator, a detection circuit that detects the output voltage of the linear regulator, and a control circuit that controls the resistance value of the variable resistor based on the detected output voltage.

According to the embodiment, the output voltage of the linear regulator can be stabilized even if there are variations in the operation state or load conditions.

### BRIEF DESCRIPTION OF THE DRAWINGS

FIG. 1 is a block diagram showing a configuration example of a semiconductor device according to a first embodiment.

FIG. 2 is a waveform diagram showing an example of operation waveforms in the semiconductor device.

FIG. 3 is a flowchart of the operation procedure during phase margin adjustment in the semiconductor device.

FIG. 4 is a block diagram showing a configuration example of a semiconductor device according to a second embodiment.

FIG. 5 is a waveform diagram showing an example of operation waveforms in the semiconductor device.

### DETAILED DESCRIPTION

Hereinafter, embodiments applying means for solving the above problems will be described in detail with reference to the drawings. For clarity of explanation, the following description and drawings are appropriately omitted and simplified. In the drawings, the same elements are denoted by the same reference numerals, and a repetitive description thereof is omitted as necessary.

In the following embodiments, when necessary for convenience, the description may be divided into multiple sections or embodiments, but unless specifically stated otherwise, they are not unrelated to each other, and one is related to the other as a modification, application, detailed description, or supplementary explanation. Also, in the following embodiments, when referring to the number of elements, etc. (including the number, numerical values, quantities, and ranges), unless specifically stated otherwise and unless it is clearly limited to a specific number in principle, it is not limited to that specific number and may be more or less than that specific number.

Furthermore, in the following embodiments, the constituent elements (including operation steps, etc.) are not necessarily essential unless specifically stated otherwise and unless it is clearly considered essential in principle. Similarly, in the following embodiments, when referring to the shapes or positional relationships of components, etc., unless specifically stated otherwise and unless it is clearly considered otherwise in principle, it is assumed to include those that are substantially approximate or similar to those shapes, etc. The same applies to the above-mentioned numbers, etc. (including the number, numerical value, quantity, and range).

### First Embodiment

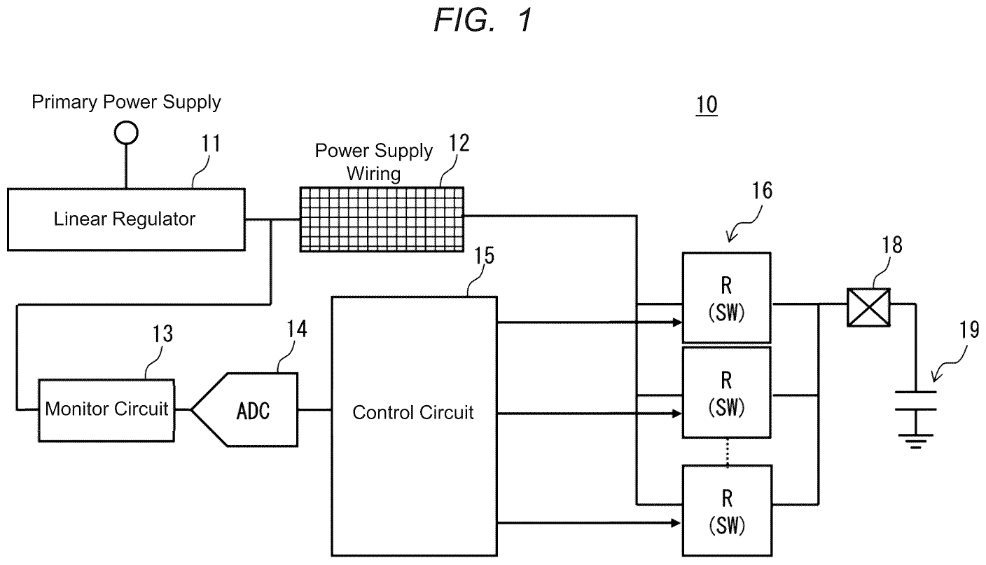

FIG. 1 is a block diagram showing a configuration example of a semiconductor device according to a first embodiment of this disclosure. In this embodiment, a semiconductor device 10 includes a linear regulator 11, a power supply wiring 12, a monitor circuit 13, an analog-to-digital converter (ADC) 14, a control circuit 15, and a variable resistor 16. The semiconductor device 10 may be configured as an MCU or a System on a Chip (SoC) but is not particularly limited.

The linear regulator 11 steps down the primary power supply voltage to a secondary voltage and outputs the stepped-down secondary voltage as ISOVDD. As well known, the linear regulator 11 has a control element internally. The linear regulator 11 maintains the output secondary voltage at a constant voltage by controlling the resistance of the internal control element according to the output voltage.

The output voltage of the linear regulator is supplied to the load via the power supply wiring 12. For example, the power supply wiring 12 includes wiring formed in a mesh pattern within the chip. The power supply wiring 12 is connected to each of one or more functional blocks formed in the semiconductor device 10.

The variable resistor 16 is connected in series with the power supply wiring 12 with respect to the output voltage of the linear regulator 11. The variable resistor 16 includes a plurality of resistors connected in parallel with each other. Switch elements such as Metal-Oxide-Semiconductor (MOS) transistors may be used for the resistors. In the variable resistor 16, the overall resistance value is variably controlled by changing the number of switch elements controlled to be “ON”.

The semiconductor device 10 has an external terminal 18, and the variable resistor 16 is inserted in series between the power supply wiring 12 and the external terminal 18. An external capacitor 19 may be connected to the external terminal 18. In the semiconductor device 10, the phase margin characteristics of the linear regulator 11 can be adjusted by the variable resistor 16 and the external capacitor 19.

The monitor circuit 13 generates a voltage that varies depending on the output voltage of the linear regulator 11. For example, the monitor circuit 13 includes a voltage divider circuit. The voltage divider circuit includes, for example, a plurality of resistors connected in series between the primary power supply and ground. The ADC 14 generates a digital signal corresponding to the voltage generated by monitor circuit 13. In this embodiment, the ADC 14 is used as a detection circuit for detecting the output voltage of the linear regulator 11.

The control circuit 15 generates a control signal to be output to the variable resistor 16 according to the digital value output from the ADC 14. For example, the control circuit 15 includes any logic circuit and sequential circuit. The control circuit 15 may include a Programmable Logic Device (PLD) such as a Field Programmable Gate Array (FPGA). The control circuit 15 outputs control signals individually to each resistor of the variable resistor 16. The control circuit 15 controls the resistance value of the variable resistor 16 by selectively controlling the switch elements used as resistors in the variable resistor 16 to be “ON”or “OFF”.

The control circuit 15 determines whether the output voltage of the linear regulator 11 is oscillating based on the digital value output from ADC 14. The control circuit 15 compares the output voltage of the linear regulator 11 with a High side (H-side) threshold value and a Low side (L-side) threshold value. Here, the H-side threshold value is greater than the L-side threshold value. More precisely, the control circuit 15 compares the digital value output from the ADC 14 with a first threshold value corresponding to the H-side threshold value and a second threshold value corresponding to the L-side threshold value. The control circuit 15 determines whether the output voltage is oscillating based on the comparison result.

For example, the control circuit 15 counts the number of times the output voltage of the linear regulator 11 fluctuates beyond the range between the H-side threshold value and the L-side threshold value during a predetermined oscillation determination period. The control circuit 15 determines whether the output voltage is oscillating based on the counted number of times. If the control circuit 15 determines that the output voltage is oscillating, it controls the resistance value of the variable resistor 16.

In this embodiment, the control circuit 15 controls the resistance value of the variable resistor 16 based on the digital value output from the ADC 14 during the adjustment of the phase margin characteristics. The adjustment of the phase margin characteristics does not need to be performed continuously during the operation of the semiconductor device 10. The adjustment of the phase margin characteristics may be performed periodically or intermittently at irregular intervals. The monitor circuit 13 may have a switch that switches the connection of the ADC 14 between the voltage divider circuit and the external input terminal of the semiconductor device 10. The switch connects the external input terminal and the ADC 14 during periods when the adjustment of the phase margin characteristics is not performed. In that case, the ADC 14 can generate a digital value corresponding to the voltage input from the external input terminal and output the generated digital value to a functional block not shown in the figure.

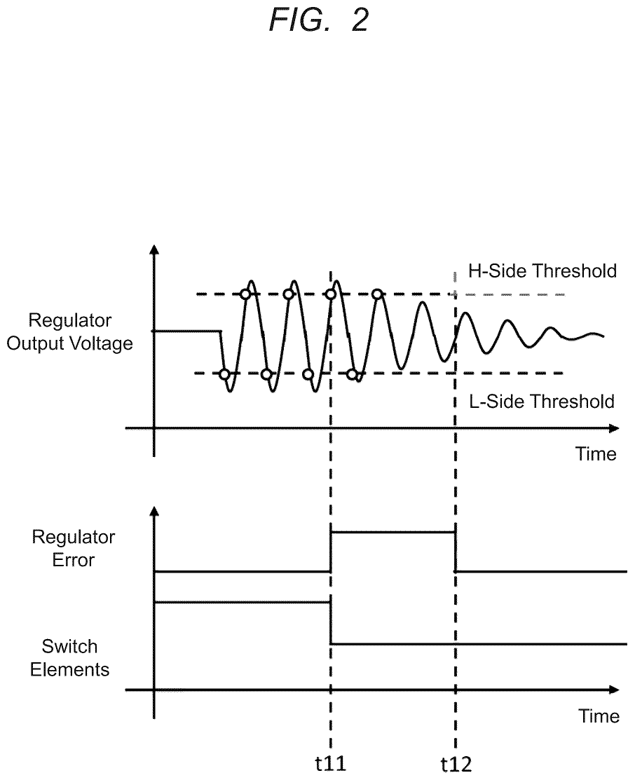

FIG. 2 is a waveform diagram showing an example of operation waveforms in the semiconductor device 10. The ADC 14 detects the regulator output voltage, i.e., the voltage output from the linear regulator 11 to the power supply line 12. The ADC 14 detects the regulator output voltage at a predetermined sampling period. In the initial state, the control circuit 15 assumes that all the switch elements used as resistors in the variable resistor 16 are turned ON.

The control circuit 15 detects whether the output voltage of the linear regulator 11 is higher than the H-side threshold based on the digital value output from the ADC 14, for example. The control circuit 15 also detects whether the output voltage of the linear regulator 11 is lower than the L-side threshold. During the oscillation determination period, the control circuit 15 counts the number of times the regulator output voltage is detected to be higher than the H-side threshold and the number of times it is detected to be lower than the L-side threshold. If the counted number of times exceeds a predetermined number, the control circuit 15 detects a regulator error, i.e., that the linear regulator 11 is oscillating. In the example of FIG. 2, the regulator output voltage fluctuates beyond the range between the H-side threshold and the L-side threshold, and the control circuit 15 detects a regulator error at time t11.

When a regulator error is detected, the control circuit 15 increases the resistance value of the variable resistor 16. Here, although the phase margin becomes more stable as the resistance increases, the load fluctuation tolerance conversely decreases. Therefore, after detecting a regulator error, the control circuit 15 gradually increases the resistance value of the variable resistor 16. The control circuit 15 gradually increases the resistance value of the variable resistor 16 by gradually increasing the number of switch elements controlled to be “OFF” in the variable resistor 16.

For example, the control circuit 15 controls the resistance value of the variable resistor 16 in three stages: “small”, “medium”, and “large”. Immediately after a regulator error is detected, the control circuit 15 controls the resistance value of the variable resistor 16 to “small”. When controlling the resistance value of the variable resistor 16 to “small”, the control circuit 15, for example, controls 10% of the switch elements to be “OFF” relative to the total number of switch elements included in the variable resistor 16.

After controlling the resistance value of the variable resistor 16 to “small”, the control circuit 15 determines whether the number of times the regulator output voltage fluctuates beyond the range between the H-side threshold and the L-side threshold during the oscillation determination period is greater than a predetermined number. If the number of times the regulator output voltage fluctuates beyond the range between the H-side threshold and the L-side threshold becomes less than the predetermined number, the control circuit 15 cancels the regulator error. In the example of FIG. 2, the control circuit 15 cancels the regulator error at time t12.

If the number of times the regulator output voltage fluctuates beyond the range between the H-side threshold and the L-side threshold during the oscillation determination period exceeds the predetermined number after controlling the resistance value of the variable resistor 16 to “small”, the control circuit 15 controls the resistance value of the variable resistor 16 to “medium”. When controlling the resistance value of the variable resistor 16 to “medium”, the control circuit 15, for example, controls 50% of the switch elements to be “OFF” relative to the total number of switch elements included in the variable resistor 16. After controlling the resistance value of the variable resistor 16 to “medium”, if the fluctuation of the regulator output voltage subsides, the control circuit 15 cancels the regulator error.

If the number of times the regulator output voltage fluctuates beyond the range between the H-side threshold and the L-side threshold during the oscillation determination period exceeds the predetermined number after controlling the resistance value of the variable resistor 16 to “medium”, the control circuit 15 controls the resistance value of the variable resistor 16 to “large”. When controlling the resistance value of the variable resistor 16 to “large”, the control circuit 15, for example, controls 90% of the switch elements to be “OFF” relative to the total number of switch elements included in the variable resistor 16. After controlling the resistance value of the variable resistor 16 to “large”, if the fluctuation of the regulator output voltage subsides, the control circuit 15 cancels the regulator error. Even if the resistance value of the variable resistor 16 is controlled to “large”, if the regulator output voltage fluctuates beyond the range between the H-side threshold and the L-side threshold, it is determined to be abnormal oscillation, and a reset may be issued to the semiconductor device 10.

In the test of the semiconductor device 10, there may be a case where an external power supply voltage is supplied to the power supply line 12 from the external terminal 18. In such a case, to suppress the voltage drop in the variable resistor 16, all the switch elements in the variable resistor 16 may be controlled to be ON. For example, the semiconductor device 10 has an OR circuit between the control circuit 15 and the variable resistor 16. The OR circuit includes a plurality of OR gates corresponding to each switch element of the variable resistor 16. Each OR gate receives a control signal output from the control circuit 15 and a test mode signal. The test mode signal is usually negated to the L level. In that case, each OR gate outputs the control signal output from the control circuit 15 to the variable resistor 16. The test mode signal is asserted to the H level during the test of the semiconductor device 10. In that case, each OR gate outputs an H-level signal, and all the switch elements of the variable resistor 16 are controlled to be ON. By controlling all the resistors of the variable resistor 16 to be ON during the test, the voltage drops in the variable resistor 16 of the external power supply voltage supplied from the external terminal during the test can be minimized.

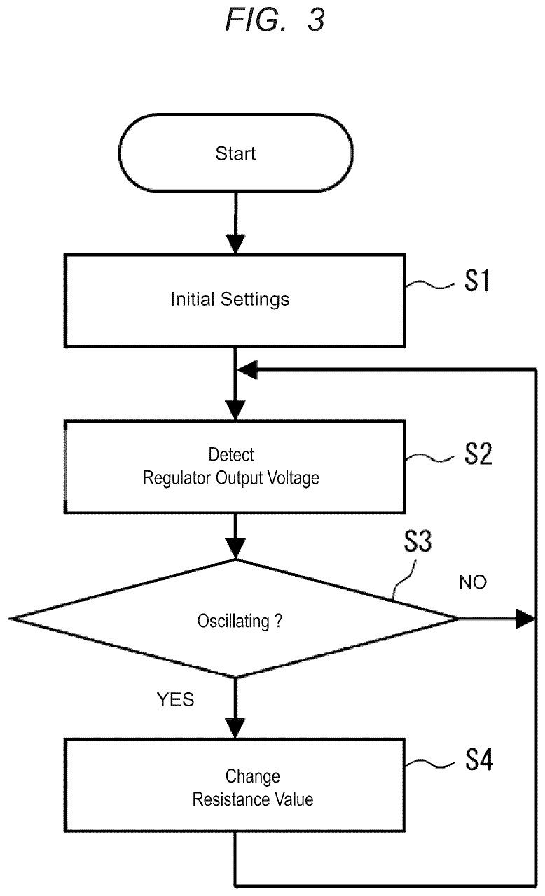

Next, the operation procedure will be described. FIG. 3 is a flowchart of the operation procedure during phase margin adjustment in the semiconductor device 10. In the semiconductor device 10, initial settings are performed (step S1). The initial settings include settings related to the detection of oscillation. In step S1, the output value of the ADC 14 corresponding to the H-side threshold and the output value of the ADC 14 corresponding to the L-side threshold are set in control circuit 15. Also, in the control circuit 15, a predetermined number of times for determining oscillation is set. In step S1, the switch elements of the variable resistor 16 controlled to be “ON”in the initial state are set in the control circuit 15.

The linear regulator 11 generates a secondary voltage output to the power supply line 12 from the primary power supply voltage. The ADC 14 detects regulator output voltage via monitor circuit 13 (step S2). The control circuit 15 determines whether the linear regulator is oscillating based on the digital value output from the ADC 14 (step S3). In step S3, the control circuit 15 counts the number of times the regulator output voltage fluctuates beyond the range between the H-side threshold and the L-side threshold. If the counted number of times exceeds the predetermined number, the control circuit 15 determines that the linear regulator 11 is oscillating.

If it is determined in step S3 that the linear regulator 11 is oscillating, the control circuit 15 changes the control signal output to the variable resistor 16 to change the resistance value of the variable resistor 16 (step S4). Then, the process returns to step S2, and the regulator output voltage is detected. If it is determined in step S3 that the linear regulator 11 is not oscillating, the process returns to step S2, and the regulator output voltage is detected.

In this embodiment, the control circuit 15 controls the resistance value of the variable resistor 16 by changing the number of switch elements controlled to be ON in the variable resistor 16 according to the output voltage of the linear regulator 11. In this embodiment, even if there are variations in the operation state or load conditions in the semiconductor device 10, such as changes in the primary power supply voltage, changes in external resistors, or transitions in operating modes, the control circuit 15 can adjust the resistance value of the variable resistor 16 according to the variations in the operation state or load conditions. Therefore, the semiconductor device 10 can stabilize the output voltage of the linear regulator 11.

### Second Embodiment

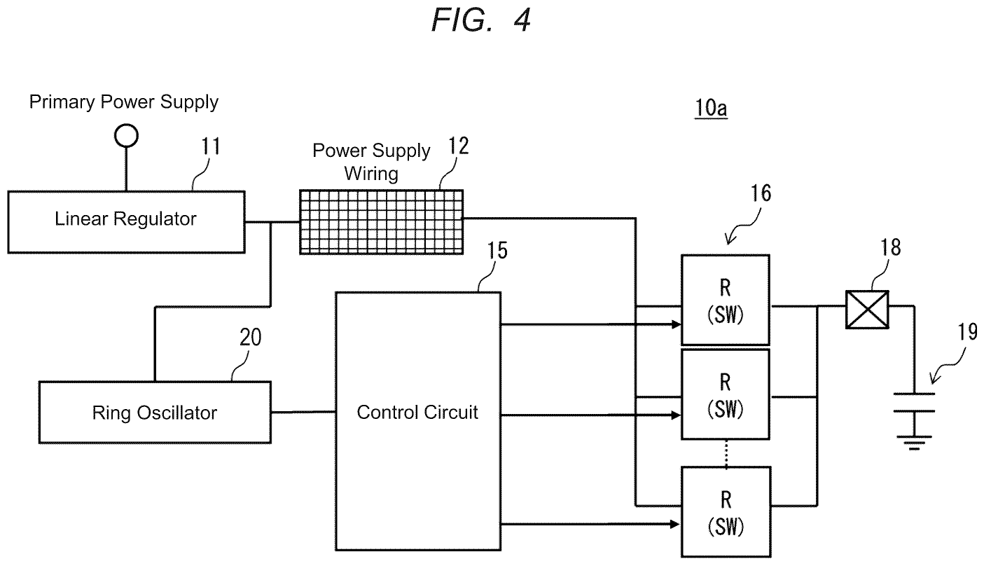

FIG. 4 is a block diagram showing a configuration example of a semiconductor device according to a second embodiment of the present disclosure. The semiconductor device 10a shown in FIG. 4 includes a ring oscillator 20. The ring oscillator 20 is used as a detection circuit for detecting the output voltage of the linear regulator 11 in the semiconductor device 10a. The control circuit 15 controls the resistance value of the variable resistor 16 using the output signal of the ring oscillator 20. Other configurations may be the same as the configuration of the semiconductor device 10 in the first embodiment.

The ring oscillator 20 is an oscillator that operates based on the output voltage of the linear regulator 11. The period of the pulse signal output by the ring oscillator 20 changes depending on the output voltage of the linear regulator 11. The control circuit 15 counts the pulses of the pulse signal output from the ring oscillator 20 every predetermined period T. The pulse count in the predetermined period T becomes larger as the output voltage of the linear regulator 11 is higher. The control circuit 15 generates a control signal to be output to the variable resistor 16 using the pulse count.

In this embodiment, the control circuit 15 determines whether the output voltage of the linear regulator 11 is oscillating based on the pulse count. The control circuit 15 compares the pulse count in the predetermined period T with the H-side pulse count threshold and the L-side pulse count threshold. The H-side pulse count threshold indicates the pulse count in the predetermined period T when the operating voltage of the ring oscillator 20 is at the H-side threshold. The H-side pulse count threshold is also referred to as the first pulse count threshold. The L-side pulse count threshold indicates the pulse count during predetermined period T when the operating voltage of the ring oscillator 20 is at the L-side threshold. The L-side pulse count threshold is also referred to as the second pulse count threshold. The control circuit 15 determines whether the output voltage is oscillating based on the comparison result.

The control circuit 15 counts the number of times the regulator output voltage fluctuates beyond the range between the H-side threshold and the L-side threshold during a predetermined oscillation determination period. Specifically, the control circuit 15 counts the number of times it is detected that the pulse count is greater than the H-side pulse count threshold and the number of times it is detected that the pulse count is less than the L-side pulse count threshold during the oscillation determination period. The oscillation determination period can be set to an integer multiple of the predetermined period T during which the number of pulses is counted. If the counted number of times is greater than a predetermined number, the control circuit 15 determines that the output voltage of the linear regulator 11 is oscillating. If it is determined that the output voltage is oscillating, the control circuit 15 controls the resistance value of the variable resistor 16.

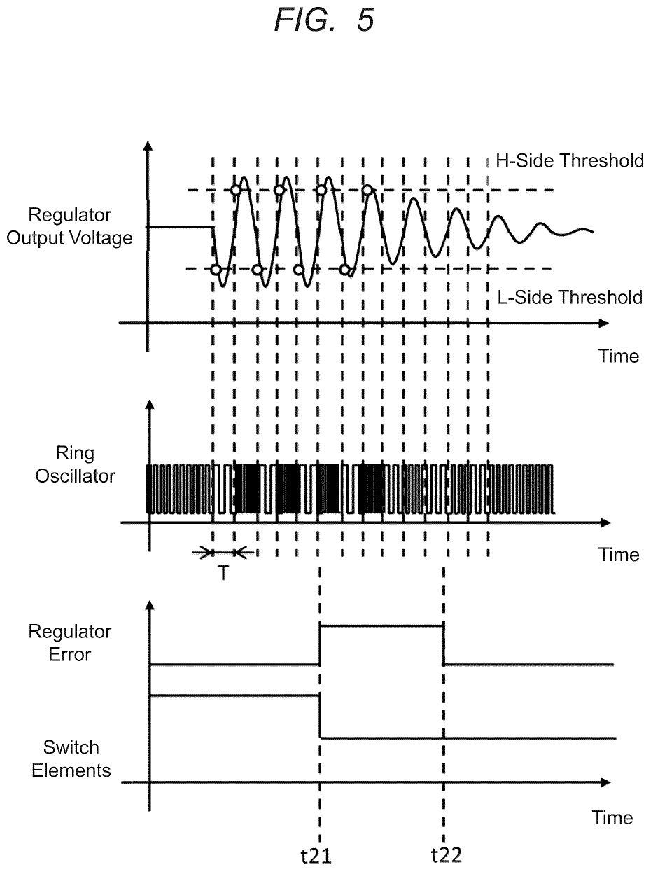

FIG. 5 is a waveform diagram showing an example of waveform operations in the semiconductor device 10a. The ring oscillator 20 oscillates at a period corresponding to the regulator output voltage, that is, the voltage output from the linear regulator 11 to the power supply line 12. The control circuit 15 counts the number of pulses of the pulse signal output from the ring oscillator 20 every predetermined period T.

The control circuit 15 detects whether the output voltage of the linear regulator 11 is higher than the H-side threshold based on the pulse count, that is, the counted number of pulses. If the pulse count is greater than the H-side pulse count threshold, the control circuit 15 detects that the output voltage of the linear regulator 11 is higher than the H-side threshold. Also, the control circuit 15 detects whether the output voltage of the linear regulator 11 is lower than the L-side threshold based on the pulse count. If the pulse count is less than the L-side pulse count threshold, the control circuit 15 detects that the output voltage of the linear regulator 11 is lower than the L-side threshold. The control circuit 15 counts the number of times the regulator output voltage fluctuates beyond the range between the H-side threshold and the L-side threshold during a predetermined oscillation determination period.

If the number of counts during the oscillation determination period is greater than a predetermined number, the control circuit 15 detects a regulator error, that is, that the linear regulator 11 is oscillating. In the example of FIG. 5, the regulator output voltage fluctuates beyond the range between the H-side threshold and the L-side threshold, and the fluctuation of the pulse count during the predetermined period T is large. In the example of FIG. 5, control circuit 15 detects a regulator error at time t21.

If a regulator error is detected, the control circuit 15 increases the resistance value of the variable resistor 16. The control of the resistance value of the variable resistor 16 may be the same as the control described in the first embodiment. For example, if a regulator error is detected, the control circuit 15 gradually increases the resistance value of the variable resistor 16 by gradually increasing the number of switch elements controlled to be “OFF” in the variable resistor 16. If the number of times the regulator output voltage fluctuates beyond the range between the H-side threshold and the L-side threshold becomes less than a predetermined number, the control circuit 15 cancels the regulator error. In the example of FIG. 5, the control circuit 15 cancels the regulator error at time t22.

In this embodiment, the control circuit 15 detects fluctuations in the output voltage of the linear regulator 11 according to the signal output by the ring oscillator 20. Even with such a configuration, the semiconductor device 10 can stabilize the output voltage of the linear regulator 11, as in the first embodiment.

Although the invention made by the inventor has been specifically described based on the embodiment, the present invention is not limited to the embodiment already described, and it is needless to say that various modifications can be made without departing from the gist thereof.

What is claimed is:

1. A semiconductor device comprising:
a linear regulator that steps down a primary power supply voltage to a secondary voltage and outputs the secondary voltage;
a variable resistor connected in series with a power supply line that supplies the output voltage to one or more loads with respect to the output voltage of the linear regulator;
a detection circuit that detects the output voltage; and
a control circuit that controls the resistance value of the variable resistor based on the detected output voltage, comprising a semiconductor device.

2. The semiconductor device according to claim 1,
wherein the control circuit determines whether the output voltage is oscillating based on the detected output voltage and controls the resistance value of the variable resistor if it is determined that the output voltage is oscillating.

3. The semiconductor device according to claim 2,
wherein the control circuit counts the number of times the output voltage fluctuates beyond the range between a first threshold of the output voltage and a second threshold of the output voltage during a predetermined oscillation determination period and determines whether the output voltage is oscillating based on the counted number of times.

4. The semiconductor device, according to claim 2,
wherein the control circuit controls the resistance value of the variable resistor by gradually increasing the resistance value of the variable resistor.

5. The semiconductor device according to claim 1,
wherein the variable resistor has a plurality of switch elements connected in parallel with each other, and the control circuit controls the resistance value of the variable resistor by changing the number of switch elements controlled to be ON.

6. The semiconductor device according to claim 1,
wherein the variable resistor is inserted in series between an external terminal and the power supply line.

7. The semiconductor device, according to claim 1,
wherein the detection circuit includes an analog-to-digital converter that outputs a digital value corresponding to the output voltage.

8. The semiconductor device according to claim 7,
wherein the control circuit compares the digital value with a first threshold and a second threshold smaller than the first threshold, determines whether the output voltage is oscillating based on the result of the comparison, and controls the resistance value of the variable resistor if it is determined that the output voltage is oscillating.

9. The semiconductor device according to claim 8,
wherein the control circuit counts the number of times the digital value is determined to be greater than the first threshold and the number of times the digital value is determined to be smaller than the second threshold during a predetermined oscillation determination period, and determines that the output voltage is oscillating if the counted number of times is greater than a predetermined number.

10. The semiconductor device according to claim 1,
wherein the detection circuit includes an oscillator that oscillates at a period corresponding to the output voltage.

11. The semiconductor device according to claim 10,
wherein the control circuit counts the pulses of the signal output from the oscillator during a predetermined period and controls the resistance value of the variable resistor based on the counted number of pulses.

12. The semiconductor device according to claim 11,
wherein the control circuit compares the counted number of pulses with a first pulse count threshold and a second pulse count threshold smaller than the first pulse count threshold, determines whether the output voltage is oscillating based on the result of the comparison, and controls the resistance value of the variable resistor if it is determined that the output voltage is oscillating.

13. The semiconductor device according to claim 12,
wherein the control circuit counts the number of times the counted number of pulses is determined to be greater than the first pulse count threshold and the number of times the counted number of pulses is determined to be smaller than the second pulse count threshold during a predetermined oscillation determination period, and determines that the output voltage is oscillating if the counted number of times is greater than a predetermined number.

14. A control method for a semiconductor device that steps down a primary power supply voltage to a secondary voltage in a linear regulator, outputs the secondary voltage from the linear regulator, detects the output voltage of the linear regulator, and controls the resistance value of a variable resistor connected in series with a power supply line that supplies the output voltage to one or more loads based on the detected output voltage.
